(19) United States
(12) Patent Application Publication
(10) Pub. No.: US 2026/0178274 A1
(43) Pub. Date: Jun. 25, 2026

(54) PROCESSOR AND METHOD WITH ACCELERATOR ACCESS CONTROL

(71) Applicant: Samsung Electronics Co., Ltd., Suwon-si (KR)

(72) Inventors: Soonwan KWON, Suwon-si (KR); Jangho AN, Suwon-si (KR); Jaehyuk LEE, Suwon-si (KR)

(73) Assignee: Samsung Electronics Co., Ltd., Suwon-si (KR)

(21) Appl. No.: 19/386,333

(22) Filed: Nov. 12, 2025

(30) Foreign Application Priority Data
Dec. 24, 2024 (KR) 10-2024-0195241

(51) Int. Cl. G06F 5/06; G06F 9/30

(52) U.S. Cl. CPC G06F 5/06; G06F 9/30101

(57) ABSTRACT

An operating method of a processor includes: setting, according to a setting of a control and status register (CSR) included in a core, a designated register as a streaming pointer for transmitting and receiving data to and from a streaming accelerator, wherein the designated register is included in a general-purpose register file according to an instruction set architecture (ISA) of the core; and based on an instruction for the core either being a memory read instruction having the streaming pointer as a source register or being a memory write instruction having the streaming pointer as a destination register, performing either the memory read instruction or the memory write instruction by accessing an input first in first out (FIFO) buffer or an output FIFO buffer of the streaming accelerator.

### CROSS-REFERENCE TO RELATED APPLICATIONS

This application claims the benefit under 35 USC § 119(a) of Korean Patent Application No. 10-2024-0195241, filed on December 24, 2024, in the Korean Intellectual Property Office, the entire disclosure of which is incorporated by reference herein for all purposes.

### BACKGROUND

### 1. Field

The following description relates to a processor and an operating method of the processor.

### 2. Description of Related Art

For artificial intelligence (AI) applications utilizing video and audio data, specialized AI accelerators may be used together with processors such as a central processing unit (CPU). As an example application, an AI-based processor may be configured to include a dedicated AI accelerator to perform small-scale AI operations with low power consumption. The AI-based processor may include a traditional microprocessor for executing and controlling programs, a dedicated accelerator for AI operations, and/or data read/write devices for efficiently fetching data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an operating method of a processor includes: setting, according to a setting of a control and status register (CSR) included in a core, a designated register as a streaming pointer for transmitting and receiving data to and from a streaming accelerator, wherein the designated register is included in a general-purpose register file according to an instruction set architecture (ISA) of the core; and based on an instruction for the core either being a memory read instruction having the streaming pointer as a source register or being a memory write instruction having the streaming pointer as a destination register, performing either the memory read instruction or the memory write instruction by accessing an input first in first out (FIFO) buffer or an output FIFO buffer of the streaming accelerator.

The designated register may be a hardwired zero-register specified by the ISA of the core.

The operating method may further include changing the setting of the CSR to cause the designated register to stop functioning as the streaming pointer.

Performing data reading from the output FIFO buffer may be based on the instruction being the read instruction having the streaming pointer as a read address; and performing data writing to the input FIFO buffer may be based on the instruction being the write instruction having the streaming pointer as a write address.

The performing of the data reading may include reading an operation result of the streaming accelerator from the output FIFO buffer using the streaming pointer.

The performing of the data reading may further include waiting for the operation result to be stored in response to the operation result of the streaming accelerator not residing in the output FIFO buffer.

The performing of the data writing may include writing by recording data read from a memory into the input FIFO buffer using the streaming pointer.

The performing of the data writing may further include suspending the data writing by temporarily stalling a pipeline in response to the input FIFO buffer being full.

The operating method may further include: while the setting of the CSR remains set and designated register continues to function as the streaming pointer, performing a second instruction of the core which has the designated register as a parameter thereof by using the designated register as defined by the ISA.

The operating method may further include: setting the CSR based on a third instruction of the core, wherein the CSR indicates either whether the streaming pointer is used, designation of the streaming pointer, or a control register for operating a direct memory access (DMA) device.

The operating method may further include: fetching, according to the setting of the CSR, weight data or input data to an in-memory computing (IMC) device included in the streaming accelerator through the input FIFO buffer by controlling the control register for operating the DMA device.

The operating method may further include: directly accessing, as instructed by the core, memory through a direct memory access (DMA) device.

In another general aspect, a processor includes: an accelerator circuit including an input first in first out (FIFO) buffer, an output FIFO buffer, and a streaming accelerator configured to perform an operation on data received from the input FIFO buffer and to store a result of the operation into the output FIFO buffer; and a core configured to perform an instruction by setting, according to a setting of a control and status register (CSR), a designated register as a streaming pointer for transmitting and receiving data to and from the streaming accelerator and accessing the input FIFO buffer or the output FIFO buffer of the accelerator circuit.

Based on the instruction either being a memory read instruction having the streaming pointer as a source register or being a memory write instruction having the streaming pointer as a destination register, the core may be configured to perform the instruction by accessing the input FIFO buffer or the output FIFO buffer.

The designated register may be a hardwired zero-buffer defined by the ISA.

The streaming accelerator may include: a vector engine, which is a single instruction multiple data (SIMD)-based operation device configured to operate a plurality of pieces of data simultaneously; and an in-memory computing (IMC) device configured to perform a vector-by-matrix multiplication (VMM) operation on data stored into the IMC device from a memory.

The core may be configured to, according to the setting of the CSR, map the streaming pointer to a write port of the input FIFO buffer or to a read port of the output FIFO by checking, in a load/store unit (LSU) or a decoder unit, whether the designated register is used as a source register or a destination register of the instruction.

The core may be configured to: in response to the instruction being a read instruction that includes the streaming pointer as a read address thereof, perform data reading by reading an operation result of the streaming accelerator from the output FIFO buffer; and in response to the instruction being a write instruction that includes the streaming pointer as a write address thereof, perform data writing by recording data read from a memory into the input FIFO buffer.

The processor may further include: a direct memory access (DMA) device configured to read data from a memory and transmit the data to the input FIFO buffer and read data from the output FIFO buffer and transmit the data to the memory or to the input FIFO buffer.

In another general aspect, a processor includes: an accelerator including an in-memory computing (IMC) device and/or a vector engine; a core having a register file that includes a zero-register; an input first in first out (FIFO) buffer and an output FIFO buffer providing communication into and out of the accelerator, respectively; and the processor configured to: turn a setting in a control and status register (CSR) of the core on and off, based on the setting being on and based on a first instruction of the core having the zero-register as a parameter thereof, executing the first instruction by either writing data of the first instruction to the input FIFO buffer or reading data of the first instruction from the output FIFO buffer, and based on the setting being off and based on a second instruction of the core having the zero-register as a parameter thereof, executing the second instruction by reading hardwired zeros from the zero-buffer.

Other features and aspects will be apparent from the following detailed description, the drawings, and the claims.

### BRIEF DESCRIPTION OF THE DRAWINGS

FIG. 1 illustrates example structure of a processor, according to one or more embodiments.

FIG. 2 illustrates example structure of an in-memory computing (IMC) device, according to one or more embodiments.

FIG. 3 illustrates example operations of a core and a streaming accelerator according to a process pipeline, according to one or more embodiments.

FIG. 4 illustrates an example of an operation between a processor and a memory, according to one or more embodiments.

FIG. 5 illustrates an example of an operation in which a processor reads weight data from a memory and stores the weight data in an accelerator circuit, according to one or more embodiments.

FIG. 6 illustrates an example of a process in which a processor reads input data from a memory and transfers, to a core, a result obtained by performing an operation on the input data in an accelerator circuit, according to one or more embodiments.

FIG. 7 illustrates an example of a process in which a processor stores a post-processing result of a core into a memory, according to one or more embodiments.

FIG. 8 illustrates an example of an operating method of a processor, according to one or more embodiments.

FIG. 9 illustrates an example of an operating method of a processor, according to one or more embodiments.

Throughout the drawings and the detailed description, unless otherwise described or provided, it may be understood that the same or like drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles "a," "an," and "the" are intended to include the plural forms as well, unless the context clearly indicates otherwise. As used herein, the term "and/or" includes any one and any combination of any two or more of the associated listed items. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being "connected to," "coupled to," or "joined to" another component or element, it may be directly "connected to," "coupled to," or "joined to" the other component or element, or there may reasonably be one or more other components or elements intervening therebetween. When a component or element is described as being "directly connected to," "directly coupled to," or "directly joined to" another component or element, there can be no other elements intervening therebetween. Likewise, expressions, for example, "between" and "immediately between" and "adjacent to" and "immediately adjacent to" may also be construed as described in the foregoing.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term "may" herein with respect to an example or embodiment, e.g., as to what an example or embodiment may include or implement, means that at least one example or embodiment exists where such a feature is included or implemented, while all examples are not limited thereto.

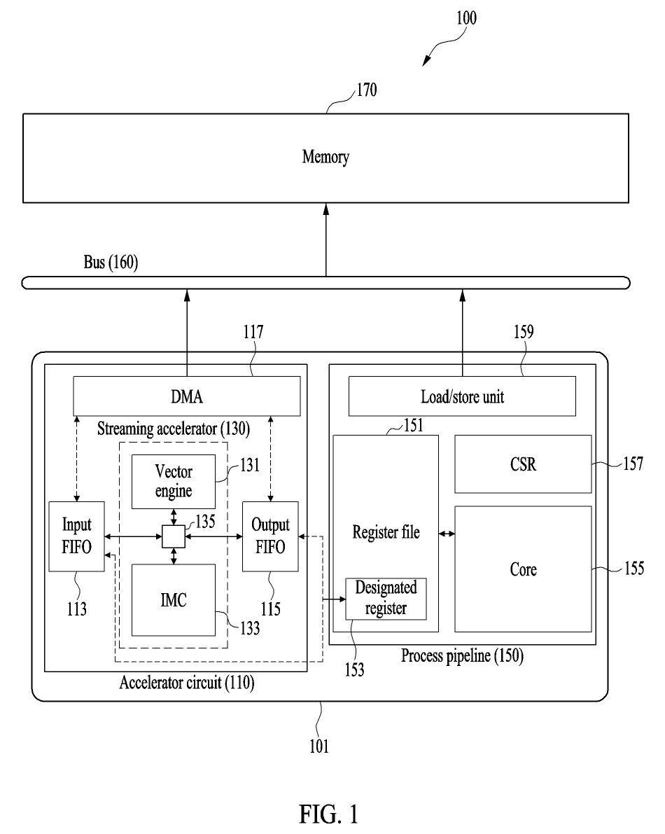

FIG. 1 illustrates example structure of a processor, according to one or more embodiments. Diagram 100 shows structure of a processor 101.

The processor 101 may be a microprocessor including an in-memory computing (IMC) device 133 that directly includes an IMC operator; the IMC device 133 may efficiently control input/output for the IMC operator and efficient performance of preprocessing and/or postprocessing operations. The IMC device 133 may be included in the processor 101 in the form of an IMC accelerator, to enhance low-power characteristics of operations. The IMC device 133 generally functions as a memory but is also capable of performing an operation (with the operator) on data stored in the IMC device 133. That is, data may be read/written from/to the IMC device 133 with memory commands using a memory-like addressing/access scheme (e.g., cross-bar), and the data may be retained in the IMC device 133 until the processor 101, for example, overwrites the data with new data that is written into the IMC device 133. While data is stored in the IMC device 133, the operation (e.g., multiplication) of the operator may be applied to the stored data; the data may remain stored in (and stationary within) the IMC device 133 before, during and after the operation is performed, e.g., until the data is overwritten, flushed, or the like. The operation (e.g., multiply, multiple-and-accumulate, etc.) of the operator may be performed such that the data stays in-place in the IMC device 133 during performance of the operation, and the in-place (stored) data and input data (an input signal) may serve as respective operators of the operation. For example, a stored word may be multiplied by an input word. In some implementations each memory cell of the IMC device 133 has its own operator to perform a bit operation (e.g., bit multiply) between an input bit value and the bit value stored in the memory cell. Outputs of some respective memory cells may go to a same accumulator, thus providing a MAC operation between their stored bit values and corresponding input bit values.

The processor 101 may exchange data with a memory 170 through a system bus 160 or may directly access the memory 170 (e.g., using direct memory address (DMA) technology). The memory 170 may also be referred to as off-chip memory.

The processor 101 may include an accelerator circuit 110 and a process pipeline 150. The IMC device 133, among other components to be discussed, may be included in the accelerator circuit 110.

The accelerator circuit 110 may also include an input first-in-first-out (FIFO) 113, an output FIFO 115, a direct memory access (DMA) device 117, and a streaming accelerator 130. The input FIFO 113 may be in the form of a buffer, for example, a queue, a set of registers, or the like. The output FIFO 115 may also be in the form of a buffer/queue/registers or the like.

The input FIFO 113 may store data that has been read from memory and is inputted into the streaming accelerator circuit 110 (e.g., data serving as an input operand). The input FIFO 113 may include a read port corresponding to a memory read command. The read port may be included in the input FIFO 113, and the input FIFO 113 may face internally (e.g., toward streaming accelerator 130). Similarly, the output FIFO 115 may store an operation result generated by the streaming accelerator 130 and from which the operation result is outputted from accelerator circuit 110 (e.g., an output generated with an input from the input FIFI 113 serving as an operand). The output FIFO 115 may include a write port corresponding to a memory write command. The write port may be included in the output FIFO, and the output FIFO may face externally.

The input FIFO 113 and the output FIFO 115 each may optionally access the DMA device 117 of the accelerator circuit 110 and/or a designated register 153 in the process pipeline 150, as indicated by the dashed arrows therebetween in FIG. 1.

The streaming accelerator 130 may perform an operation on data stored in (and inputted from) the input FIFO 113, and may store the result in the output FIFO 115.

When weight data of a neural network, for example, is stored in the memory 170, the streaming accelerator 130 may read the weight data, store the weight data in the IMC device 133, and continuously apply input data to the IMC device 133 to obtain output data. An accelerator capable of sequentially passing input data in this way to achieve a desired computation result may be referred to as a "streaming accelerator." Weight data is a non-limiting example of the type of data that may be stored in the IMC device 133, however, processing of weight data of a neural network may be particularly efficient, in terms of overall neural network performance.

The streaming accelerator 130 may include a vector engine 131 and/or the IMC device 133 (in some implementations one or the other is included, and in other implementations, both are included). The vector engine 131, if included, is a single instruction multiple data (SIMD)-based operation device capable of performing operations on multiple pieces of data simultaneously and may perform a vector operation (e.g., an operation between vectors, dot and cross products, vector normalization, a vector length operation, vector similarity analysis, etc.) that is difficult (or not possible) to perform in the IMC device 133. The IMC device 133 may receive data stored in the memory 170 and perform thereon a vector-by-matrix multiplication (VMM) operation, for example.

Each of the input and output of the streaming accelerator 130 may be transmitted through a respective independent FIFO. As noted, the input to the streaming accelerator 130 may be transmitted via the input FIFO 113, and the output (e.g., an operation result) of the streaming accelerator 130 may be transmitted via the output FIFO 115. The input FIFO 113 and the output FIFO 115 may each be accessed through the process pipeline 150 and the DMA device 117.

The streaming accelerator 130 may further include a bridge device 135 that connects an input and an output between the vector engine 131 and the IMC device 133. The bridge device 135 may include a controller capable of controlling the input and output between the vector engine 131 and the IMC device 133 and/or a configurable inter-connector.

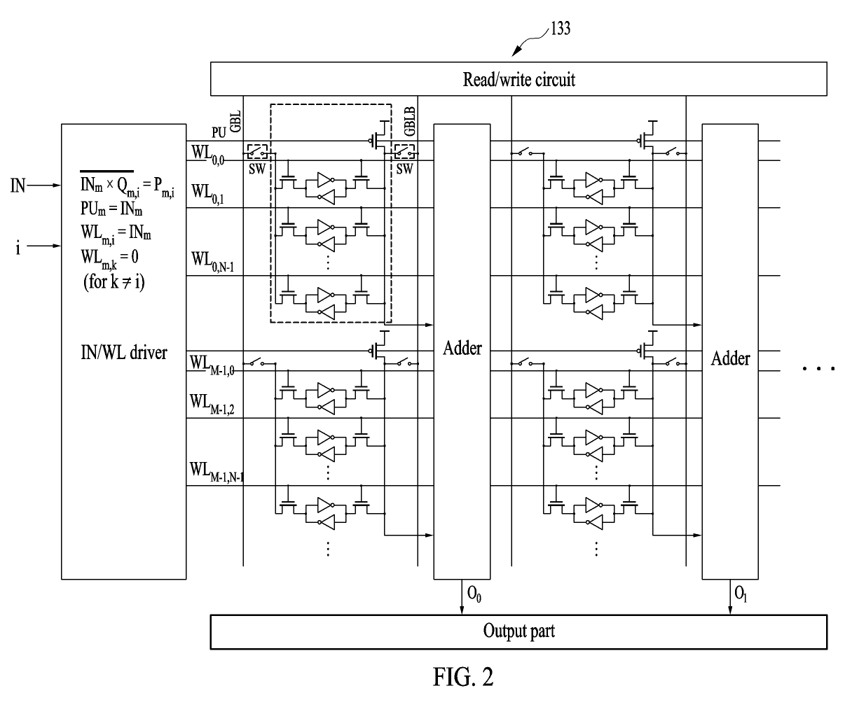

As described above, the IMC device 133 may perform an operation directly without requiring a central processing unit (CPU) or core thereof to fetch information, and may do so by storing program instructions and data in a memory. For example, as illustrated in FIG. 2, the IMC device 133 may be/include an static random access memory (SRAM)-based IMC device, but examples are not limited thereto. The IMC device 133 may enhance the effectiveness of low-power operations by minimizing/reducing data movement (e.g., between processor 101 and the memory 170) while maintaining low-power characteristics. The IMC device 133 may support not only an artificial neural network (ANN) algorithm but also a new neuromorphic algorithm, including a spiking neural network (SNN), where neurons in a model communicate through sequences of spikes. This may enable the IMC device 133 to be used as a low-power artificial intelligence (AI) processor.

The IMC device 133 may be configured in a structure connected to the vector engine 131 to optimize the operational efficiency of a system that includes the processor 101. The vector engine 131 and the IMC device 133 may be connected to each other through the bridge device 135 that links the input and output between the vector engine 131 and the IMC device 133.

The DMA device 117 may be controlled through a control and status register (CSR) 157 included in the processor 101 and may directly transfer data from the memory 170, for example, to the input FIFO 113 of the streaming accelerator 130, and may directly transfer a result from the output FIFO 115 to the memory 170, for example. The CSR 157 may be one among multiple CSRs of the processor 101. For example, the CSRs may reside in specially designated address range. Some of the CSRs in the address range may have designated/reserved RISC-V functionality, and other CSRs may be unreserved. Here, "designated CSR" refers to a CSR not specified in any versions of the RISC-V architectures.

The DMA device 117 may operate based on a DMA technique. The DMA technique, for example, may be an input/output (I/O) technique that directly transfers data to/from a memory using a DMA controller without the assistance of any (e.g., core 155) of the processor 101 by utilizing a memory buffer, a pointer, and a counter. In this case of exchanging data between the memory 170 and the accelerator circuit 110, the core 155 may exchange only status information and/or control information, while data transfer may be performed directly between I/O and memory (i.e., the data does not flow through the core 155). The core 155, for example, may be a CPU core, but examples are not limited thereto.

The DMA device 117 may, for example, implement streaming DMA for continuously transferring data in a stream format. For example, input data may be streamed into the input FIFO 113 and output data may be streamed out of the output FIFO 115. The DMA device 117 is a device that may be controlled through CSR 157, which is accessed by the core 155, and may perform read and/or write continuous data required for an AI operation. That is, the CSR 157 may be used by the core 155 to control read/write streaming. The DMA device 117 may read data from the memory 170 and transmit/stream the data to the input FIFO 113, read data from the output FIFO 115 and transmit/stream the data to the memory 170 via the system bus 160, or transmit/stream the data from the output FIFO 115 to the input FIFO 113.

The DMA device 117 may send an output of the IMC device 133 to external memory 170 via the output FIFO 115 or move the output to the input FIFO 113 to allow the core 155 to access the data. The core 155 may read output of the IMC device 133 or output of the vector engine 131, either of which is generated in a streaming format, and may read such output from the output FIFO 115 and then process various operations on/with the output.

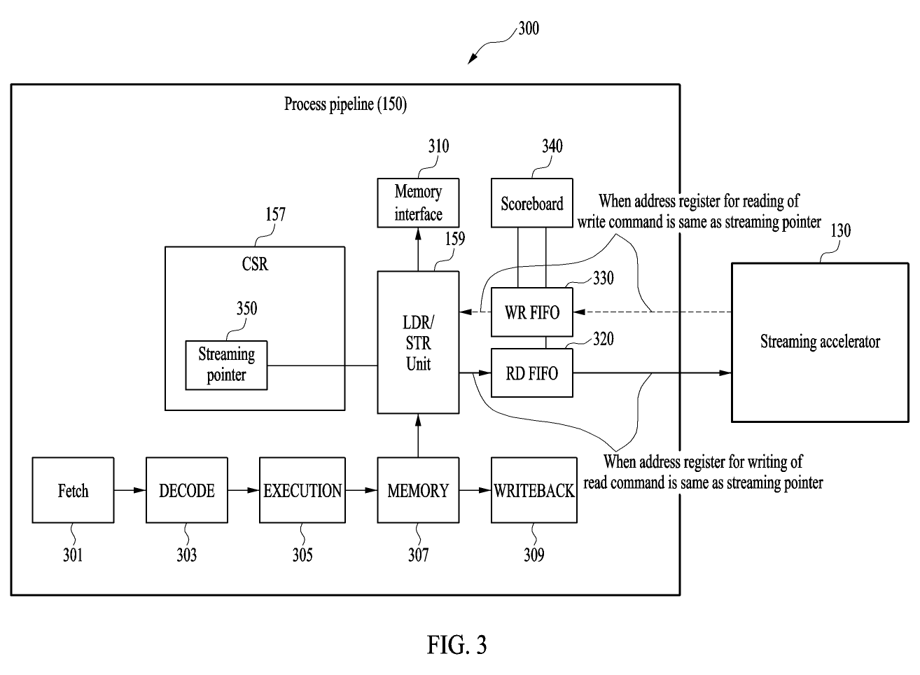

The IMC device 133 may perform an operation using data transferred by the DMA device 117 or the core 155 and output a result. For example, the IMC device 133 may configure a basic operation flow such as the one illustrated in FIG. 3.

To perform an operation, the vector engine 131 and the IMC device 133 may also operate based on instructions. The vector engine 131 and the IMC device 133 may each include an instruction cache and a loop control unit to support a function of repeatedly executing instructions of the same group or a predetermined group. Each instruction cache may be a memory space that temporarily stores frequently used instructions and data. Each loop control unit may be a hardware and/or software component configured to efficiently process repetitive/looping tasks. The loop control unit may recognize a loop structure (within instructions) and optimize repeated instructions to enhance execution speed thereof. For example, the loop control unit may perform functions such as instruction decoding, which decodes instructions within a loop to determine an execution order, iteration management, which tracks the number of iterations and performs repetitions as needed (e.g., perform the number of iterations), and/or optimization, which stores repeated instructions in an instruction cache to reduce the time spent reading instructions from a memory each time the instructions are executed.

Instructions for the vector engine 131 and the IMC device 133 may be stored in the core 155. The core 155 may transmit the stored instructions to an independent instruction processor of each operation unit in the accelerator circuit 110 (e.g., the vector engine 131 and the IMC device 133). A single instruction may be configured to execute multiple commands instead of just one, allowing the core 155 to control an entire program as a single flow. This configuration may enable the vector engine 131, the IMC device 133, and the core 155 to all execute the corresponding commands. As described below, the core 155 may reuse the assigned designated register 153 to control the transfer of data to each operation unit in the accelerator circuit 110, thereby enabling consistent program control and/or execution within the core 155.

The process pipeline 150 of the processor 101 may include a register file 151 (which may be a general-purpose register defined in an instruction set architecture (ISA) of the processor 101), the core 155, the CSR 157, and a load/store unit (LSU) 159. The process pipeline 150 may include a hardwired register and, for example, may be a process architecture of reduced instruction set RISC computer (e.g., part of a RISC-V architecture/ISA). The core 155 may obtain a designated register (e.g., designated register 153) of the general-purpose register to function as a streaming pointer; the designated register being designated to be hardwired by the ISA of the core 155. That is, the core 155 may set a designated register of the general-purpose register as a streaming pointer, and the designated register may be designated by a setting of the CSR 157.

The RISC-V ISA may be an open-source ISA used to define low-level digital data manipulation implemented in a microprocessor core. The ISA defines a set of instructions that a CPU is to execute and serves as an interface between hardware and software. RISC-V architecture/ISA may be used to develop customized processors for various applications. The RISC-V ISA may include 49 instructions that are compatible with 32-bit implementations in hardware. A word width may be used with 14 extended instructions at 64 bits and, theoretically, may support up to 128 bits. A RISC-V system may generate 32-bit addresses in relation to a program counter register. Additionally, a RISC-V system may use 32 floating-point registers for passing arguments, parameters, and result values. An x0 register (or "zero register") is hardwired to always returns "0" when read. Writing to the x0 register has no effect.

In the case of RV32, RISC-V instructions may be encoded as 32-bit instruction words. All arithmetic instructions in RISC-V, for example, may have three variables (a, b, c) such as "add a, b, c". These three variables may be divided into two sources (i.e., operands) and one destination (i.e., output/result). The instruction "add a, b, c" may be understood as a = b + c, where "b" and "c" correspond to the two sources/operands, and "a" corresponds to the single destination/result.

As noted, the register file 151 may be a space that stores data directly used by the core 155. When the process pipeline 150 corresponds to a RISC-V process architecture, the register file 151 may physically have 32 or more general purpose registers, but 32 particular registers thereof may be mapped to 32 registers in an actual program. Similarly, the RISC-V instructions may be implemented as 64-bit instructions (i.e., RV64) and may have 64 general purpose registers.

The register file 151 may equally have 32 architectural registers. However, according to a setting of the CSR 157 of the core 155 (i.e., according to a value in the CSR 157), the x0 register, which is hardwired to always be read as "0," may (i) be virtually mapped to a read port of a selected FIFO (e.g., the output FIFO 115) during a read command corresponding to a predetermined instruction and may (ii) be virtually mapped to a write port of a selected FIFO (e.g., the input FIFO 113) during a write command.

The instruction lw may be a command to read data from a memory and store the data in a register. The lw instruction is also known as a "load word" instruction. The first parameter of lw is a destination register (where the word is being loaded into) and the second parameter of the lw instruction is a source address (where the word is being loaded from). The source address may in the form of "offset(register)", meaning the source address is the address stored in "register" and with an "offset" added thereto. For example, suppose the core 155 calls the instruction "lw x1, 0(x0)". This instruction "lw x1, 0(x0)" may be a command to (i) read data from an address obtained by adding offset 0 to a value of the x0 register and (ii) store/load the read data into the x1 register. However, since the x0 register is hardwired to return "0" when read, an address value defined relative to the x0 register may be meaningless. However, in an example, the "0(x0)" (as the source address of the load instruction) may indicate that a calculation result generated by the streaming accelerator 130 is to be read from the output FIFO 115 of the streaming accelerator 130 and transferred to the x1 register, so that the data may be directly transferred to the processor pipeline. In other words, the "0(x0)" as the source address of that the load instruction, in combination with CSR 157 being "on", may signal that the load instruction is for loading data from the output FIFO 115 (i.e., "0(x0)" implicitly points to the output FIFO 115 as the source of the load).

As noted, either of the FIFOs may be in the form of a FIFO queue. Based on the "0(x0)" being the source parameter of a load instruction (for example), the accelerator circuit 110 may pop (dequeue) data (e.g., operation results from the IMC device 133 or the vector engine 131) from a FIFO queue (e.g., the output FIFO 115) that stores an output of the IMC device 133 or the vector engine 131 and transfer the popped data to the process pipeline 150.

In the case where the output FIFO 115 is referenced (e.g., as per the Iw example mentioned above, or the sw example mentioned below), when the output FIFO 115 happens to be empty, in other words, when no operation result of the streaming accelerator 130 is currently in the output FIFO 115, the core 155 may take any of several actions, such as waiting (pending/blocking) for the operation result of the streaming accelerator 130 to be stored, excluding (treating as an exception) the operation result of the streaming accelerator 130, or returning a predetermined value other than the operation result of the streaming accelerator 130.

The core 155 may store an operation result of the streaming accelerator 130 using the instruction "sw x1, 0(x0)". The "sw" instruction is an instruction to store the contents (e.g., word) of a source register (the first parameter, e.g., register x1) into a memory location/address (the second parameter). The instruction "sw x1, 0(x0)" may be a command to store a value of the x1 register into the address obtained by adding offset 0 to the value of the x0 register. Accordingly, based on the "0(x0)" being the second parameter of the sw instruction (as well as based on the "on" state of the CSR 157), the core 155 may store (e.g., push) the value of the x1 register into the output FIFO 115. Accordingly, the core (155) can store the value of the x1 register into the output FIFO 115.

The core 155 may perform instruction decoding, control, and/or an operation. The core 155 may include a register hardwired to 0, such as the x0 register of the RISC-V architecture. In addition to basic instructions, the core 155 may also have instructions specialized for controlling the IMC device 133.

The core 155, based on the setting of the CSR 157 according to a command, may (i) set the designated register 153 included among the general-purpose registers (e.g., the register file 151) as a streaming pointer that points to where to transmit and receive data to and from the streaming accelerator 130 and the core 155 may (ii) access the input FIFO 113 or the output FIFO 115 of the accelerator circuit 130 to execute a command (with data coming from or going to the address of the streaming pointer, as the case may be).

A register (e.g., the designated register 153) among the general-purpose registers may be designated as a register for performing read/write operations to/from FIFOs (e.g., the input FIFO 113 and the output FIFO 115) to transmit and receive data to and from the streaming accelerator 130. The register (e.g., designated register (153)) used for performing read/write operations to/from the FIFOs (the input FIFO 113 and the output FIFO 115) may be referred to as a "streaming pointer."

The streaming accelerator 130 may access the FIFOs (the input FIFO 113 and the output FIFO 115) using a designated register (e.g., the designated register 153) and may optionally access the memory 170 directly through a separate DMA device (e.g., the DMA device 117).

Read/write operations performed according to a streaming pointer, such as the designated register 153, may be linked to the pipeline of the core 155 and may cause a pipeline stall. In other words, accessing of the FIFO (through the streaming pointer) may occur within processing of the pipeline of the core 155 and, depending on the availability of data in the accessed FIFO, may cause a stall. For example, when an attempt is made to read an output of the IMC device 133 or the vector engine 131, but no data exists within the output FIFO 115 (the FIFO is empty), the operation of the core 155 performing the read operation may temporarily stall. In addition, when an input is provided to the IMC device 133 or the vector engine 131 to perform a write operation to the streaming pointer (streaming data into the input FIFO 113 from the address that the streaming pointer points to), but the input FIFO 113 is full, making the write operation impossible, the operation of the core 155 performing the write operation may also stall.

Even when designated as a streaming pointer, instructions other than read/write operations for the designated register 153 may be regarded as accessing a general-purpose register value of the designated register 153. That is to say, outside of its use with some instructions as indicating a streaming pointer, the designated register may still function as intended for other instructions. For example, when the processor is a RISC-V processor, the designated register 153 may be a hardwired register, such as the x0 register, which is hardwired to "0".

Whether the designated register 153 is utilized as a streaming pointer (or instead has its default ISA behavior, e.g., returning all zeros) may be set in an on/off manner through the CSR 157. The processor may set the CSR based on a command for the core 155. The CSR may, for example, indicate whether the streaming pointer is used, designation of the streaming pointer, or a control register for operating a DMA device.

Based on the setting of the CSR 157, the core 155 may check in the LSU 159 or the decoder unit whether the designated register 153 is currently being used as a source register or a destination register and may (i) map the streaming pointer to the write port of the input FIFO 113 corresponding to a memory write command or may (ii) map the streaming pointer to the read port of the output FIFO corresponding to a memory read command.

The core 155 may set a register storing a target address (destination address) of a memory write command as the designated register 153 (e.g., x0 register) to perform data writing to a FIFO (e.g., the input FIFO 113) that serves as an input to the streaming accelerator 130. In addition, the core 155 may set a register storing a source address of a memory read command as the designated register 153 (e.g., x0 register) to fetch data from the output FIFO 115 of the streaming accelerator 130.

Except for a case in which the designated register 153 (e.g., x0 register) is used as a register of the source address and/or target address (destination address) in a memory read and write commands, access to the x0 register may otherwise comply with the ISA specifications of a corresponding processor architecture (e.g., function as a zero-register).

The core 155 may determine whether to enable or disable (turn on or off) the mapping between a hardwired register, that is, the designated register 153, and FIFOs (e.g., the input FIFO 113 and the output FIFO 115) through the CSR 157. For example, when mapping between the designated register 153 and the FIFOs is set to the "on" state in the CSR 157, the core 155 may use the designated register as the source register or the destination register for lw (load word) and sw (store word) to perform read/write operations to/from the input/output FIFOs. On the other hand, when mapping between the designated register 153 and the FIFOs is set to the "off" state in the CSR 157, the core 155 may use the designated register 153 according to the ISA specifications (i.e., as a zero-register).

In general, the instruction lw may be an instruction used to read data from a memory and store the data into a register. For example, the instruction "lw t0, 24(s3)" may be to (i) read data from an address obtained by adding 24 to the value (address) residing in the s3 register and (ii) store the data into the t0 register. In addition, the instruction sw may be an instruction to store data from a register into a memory. For example, the instruction "sw t0, 24(s3)" may be to store a value residing in the t0 register into an address obtained by adding 24 to the value residing in the s3 register. Generally, the lw and sw instructions, among others, may enable data processing through the movement of data between the memory 170 and the register file 151.

Even when the mapping between the designated register 153 and the FIFOs (e.g., the input FIFO 113 and the output FIFO 115) is set to the "On" state, the core 155 may still execute instructions such as "add x1, x0, x0", which utilize/reference the designated register 153 (hardwired to "0") to set the result of an operation to "0". Even when mapping between the designated register 153 and the FIFOs is set to the "On" state, instructions other than the lw and sw instructions that do not use the designated register 153 as a source register or as a destination register may follow the ISA specifications. Incidentally, regarding terminology, the input FIFO 113 may be referred to as a "write (WR) FIFO" since the input FIFO 113 corresponds to a memory write command. The output FIFO 115 may be referred to as a "read (RD) FIFO" since the output FIFO 115 corresponds to a memory read command.

When an instruction is a read command designating a streaming pointer as a read address, the core 155 may execute the instruction by performing data reading from the output FIFO 115. The core 155 may perform data reading by using the streaming pointer to read an operation result of the streaming accelerator 130 from the output FIFO 115.

When mapping between the designated register 153 and the FIFO is set to "On" in the CSR, and a read command designates the streaming pointer as the read address, the core 155 may read data from the output FIFO 115 and store the data in the register designated by the processor.

When an instruction is a write command designating the streaming pointer as a write address, the core 155 may execute the instruction by performing data writing to the input FIFO 113. The core 155 may perform data writing by recording the data read from the memory 170 into the input FIFO 113 using the streaming pointer. When mapping between the designated register 153 and the FIFOs is set to "on" in the CSR, and the instruction is a write command designates the streaming pointer as the write address, the core 155 may record the value designated by the processor into the input FIFO 113 of the IMC device 133.

When mapping between the designated register 153 and the FIFOs is set to the "off" state in the CSR 157, the core 155 may operate according to the ISA specifications, ignoring the designated register 153 (i.e., by not accessing a FIFO). The core 155 may allocate a general-purpose register (e.g., a register in the register file 151) as a register for an operation instead of the designated register 153. In this case, data transfer to the IMC device 133 may be possible only through the DMA device 117 (i.e., not through either of the FIFOs).

The CSR 157 may control the DMA device 117 and/or the designated register 153. As noted above, the CSR 157 may be one of many CSRs used to control and monitor the state of the core 155. The many CSRs (including the CSR 157) may be used to store various system settings, control the operation of the core 155, and perform tasks such as debugging and performance monitoring. For example, the CSRs may include a timer register, an interrupt state register, a performance counter register, and the like. The CSRs (including the special CSR 157) may be used to finely adjust the operation of the core 155 and enable system software to interact with hardware (e.g., by configuring the hardware vis-à-vis setting the CSRs).

The LSU 159 may determine whether the core 155 is to access the memory 170 or is access the input/output FIFOs 113 and 115 of the streaming accelerator 130 by checking, based on setting information of the streaming pointer (e.g., in the CSR 157), whether or not the hardwired register, that is, the designated register 153, is used as a source register and/or destination register.

As described next, the LSU 159 may also manage operations of the memory 170. The LSU 159 may determine when to execute a memory operation within a memory system.

The LSU 159 may use two queues which are a load queue (LDQ) and a store queue (STQ). The LDQ may store a result obtained by calculating a load address when a load instruction is executed by the core 155. The STQ may store data corresponding to a store instruction when the store instruction is executed by the core 155. The core 155 may record the data residing in the STQ into the memory 170 via the system bus 160 at an appropriate time.

The process pipeline 150 may be tightly coupled with the streaming accelerator 130, which may be a kind of IMC IP.

Data exchanged between the streaming accelerator 130 and the process pipeline 150 may be performed through the input FIFO 113 and the output FIFO 115 connecting the streaming accelerator 130 with the process pipeline 150. Each of the input FIFO 113 and the output FIFO 115 may have two paths. One of the two paths may be an instruction pipeline of the core 155 accessed through the designated register 153, and the other may be accessed by the DMA device 117, which the core 155 may directly control via the CSR 157.

The process pipeline 150 may use the DMA device 117 that is separate from the LSU 159 and may control the DMA device 117 through the CSR 157.

The core 155 and the streaming accelerator 130 may be tightly coupled with the input FIFO 113, the output FIFO 115, and the designated register 153. The core 155 may use the CSR 157 to set a portion (e.g., a register) among general-purpose registers (e.g., a register in the register file 151) to serve as the designated register 153 that is to be used for transmitting and receiving data to and from the streaming accelerator 130. The core 155 may control the designated register 153 through the CSR 157. In the case of using a hardwired register as the designated register 153, the core 155 may effectively change the hardwired register to function as an arbitrary general-purpose register through a setting of the CSR 157. The core 155 may use, as the designated register 153, a register (e.g., the x0 register of RISC-V) of the general-purpose register, the register being hardwired to a predetermined value (e.g., "0"). A memory read command directed to (referencing) the designated register 153 may, based thereon, be performed by reading a result from the output FIFO 115. In addition, a memory write command directed to (referencing) the designated register 153 may, based thereon, be executed by providing input to the input FIFO 113. Operations other than the designated read and/or write for the designated register 153 may be performed through access to the general-purpose register as such (that is, the general-purpose register may otherwise function as a hardwired x0 register).

FIG. 2 illustrates example structure of an IMC device, according to one or more embodiments. FIG. 2 illustrates an example of the IMC device 133.

The IMC device 133, for example, may be an SRAM-based IMC accelerator in which multiplier cells are arranged in an array structure, but examples are not limited thereto.

The IMC device 133 may continuously generate output data by performing an operation (e.g., a VMM operation) between weight data and input data as the input data (or weight data) is continuously applied while the weight data (or input data) is stored in the internal memory of the IMC device 133.

The IMC device 133 may include multiplier cells, some of which are indicated by dotted lines. For example, the multiplier cells may be arranged in an array structure. The multiplier cells may be arranged along respective output lines and respective word lines. An input-wordline driver (IN/WL driver) may select a memory cell (e.g., a memory cell corresponding to i) in which a weight (Qm,i) corresponding to a target task is set among memory cells included in a multiplier cell. The IN/WL driver may individually transfer input values (INm) to the memory cells in which the weight (Qm,i) corresponding to the target task has been set, for each of the multiplier cells. Thus, when performing various tasks across cycles, the IMC device 133 may pre-set a required weight (Qm,i) for each cycle in the memory cells within each multiplier cell. When the target task changes, the IMC device 133 may perform a multiplication operation by selecting a memory cell with the weight (Qm,i) corresponding to the target task from the pre-set memory cells, without needing to load weights (corresponding to the changed task) from outside the IMC device 133.

Multiplier cells connected to the same word line may receive the same input value (INm). In each of the multiplier cells, multiplication operations may be performed in parallel with other multiplier cells. The IMC device 133 may sum outputs of the multiplier cells connected to a same column line (e.g., a same output line) using the same adder 730. One multiplier cell and another multiplier cell may output respective multiplication results in parallel. Within one multiplier cell, a multiplication operation may be performed based on a single memory cell. In M multiplier cells connected to an output line, M multiplication operations may be performed in parallel.

FIG. 3 illustrates example operations of a core and a streaming accelerator according to a process pipeline, according to one or more embodiments. In FIG. 3, diagram 300 shows the structure and operation of the process pipeline 150, which is configured to use a designated register (e.g., x0 register) as a streaming pointer 350.

A DMA device (e.g., the DMA device 117 of FIG. 1) connected to FIFOs (e.g., an RD FIFO 320 and a WR FIFO 330) of the streaming accelerator 130 may be controlled through access to the CSR 157 from a core (e.g., the core 155 of FIG. 1) and may read and write continuous data (data streaming) for an AI operation.

The DMA device in the streaming accelerator 130 may fetch data from an external memory (e.g., the memory 170 of FIG. 1) through the LSU 159, which determines when to either (i) execute a memory operation in a memory interface 310 (and/or a memory system) and transfer the data to the WR FIFO 330 or when to (ii) read data from the RD FIFO 320 and transfer the data to the external memory (or to the WR FIFO 330). Here, the WR FIFO 330 may be the "input FIFO 113" described above, and the RD FIFO 320 may be the "output FIFO 115" described above.

In the process pipeline 150, the CSR 157 may control allocation, as the streaming pointer 350, of a designated register (e.g., the x0 register hardwired to "0") of a general-purpose register and store and/or manage related information.

In the pipeline for memory read/write, the core may determine whether a register X, which indicates a memory address of a memory read instruction and a memory write instruction, is a designated register (e.g., x0 register) designated as the streaming pointer 350.

When the register X has the same value as the streaming pointer 350, in other words, when the register X is the designated register (e.g., x0 register) designated as the streaming pointer 350, writing using the designated register may be performed by the WR FIFO 330, and reading may be performed by the RD FIFO 320. In other words, when an address register for reading of a write instruction (that is, a parameter of the write instruction) is the same as the streaming pointer 350, a write operation to the WR FIFO 330 may be performed based thereon. Additionally, when an address register for writing of a read instruction (that is, a parameter of the write instruction) is the same as the streaming pointer 350, a read operation from the RD FIFO 320 may be performed based thereon.

By using a register hardwired to "0" (the designated register 153) as the address register, read/write commands may be alternatively executed as ordinary commands or as read/write operations to/from FIFOs.

In the case of a write command, when the WR FIFO 330 is full, the core may transfer a signal to a score board 340 to prevent a program from progressing. Through the score board 340, the core may temporarily stall the operation of the entire pipeline. The score board 340, in a situation in which there is access to a FIFO of the streaming accelerator 130, may detect an additional access request to an LSU (e.g., the LSU 159 of FIG. 1) and perform the role of stalling and/or resuming the pipeline 150 of the processor in hardware, thereby prevent hazards in the processor. The score board 340 may eliminate the risk of data transfer and/or execution redundancy to the streaming accelerator 130.

Additionally, when data is read from the WR FIFO 330 but output data is not generated by the streaming accelerator 130, in other words, when the WR FIFO 330 is empty, the core may also stall the operation of the entire pipeline through the score board 340.

For example, when an instruction such as "lw x1, 0(x0)" is called in the process pipeline 150, the core may pop data from a FIFO (e.g., the WR FIFO 330) that stores an output of the streaming accelerator 130. When the WR FIFO 330 is empty, an operation may be performed in a manner appropriate to the purpose, such as pending, exception, or returning a predetermined value. The process pipeline 150 may then use a result fetched from the WR FIFO 330 to generate a calculation result and store the result back into a memory. In this case, a general sw command, such as sw x1, 0(x3), may be used.

The core may store (record) a value read from the x0 register, in other words, "0", in the x1 register through the instruction "sw x1, 0(x0)". The core may set the streaming pointer 350, which maps a designated register to a FIFO, through the CSR 157, and may set whether to enable or disable the mapping (i.e., to turn the mapping on or off).

Furthermore, even when the mapping of the designated register to the FIFO is set to "on", this mapping may be applied only to predetermined instructions, such as lw and sw. For other instructions, a register value defined by a default architecture may be used as is. For example, according to RISC-V specifications, which define the x0 register as always being "0", an instruction such as "add x2, x1, x0" may perform a function of moving a value of the x1 register to an x2 register without any issues (i.e., the zero-register functions as specified by the relevant RISC-V ISA).

The process pipeline 150 may divide an instruction processing into multiple operations to process the operations in parallel to enhance the performance of the processor. The respective operations are executed simultaneously through the process pipeline 150, so the overall processing speed may be enhanced. Main operations of the process pipeline 150 may include instruction fetch 301, instruction decode 303, execution 305, memory access 307, and write back 309.

The instruction fetch 301 may correspond to the process of fetching an instruction from a memory. The instruction decode 303 may correspond to the process of decoding the instruction fetched through the instruction fetch 301 and reading a necessary register. The execution 305 may correspond to the process of performing an operation or calculating an address using data (e.g., a decoded instruction) read from a register or the like. The memory access 307 may correspond to the process of accessing a memory storing the data calculated through the execution 305. The write back 309 may correspond to the process of storing the results (e.g., operation results, read results, etc.) of the previously performed operations in a register.

When the aforementioned operations are executed simultaneously, each instruction may be processed at a different operation of the pipeline. For example, while the first instruction is at the execution 305 operation, the second instruction may be at the instruction decode 303 operation. As the operations in the process pipeline 150 are executed simultaneously, the overall processing time may be significantly reduced.

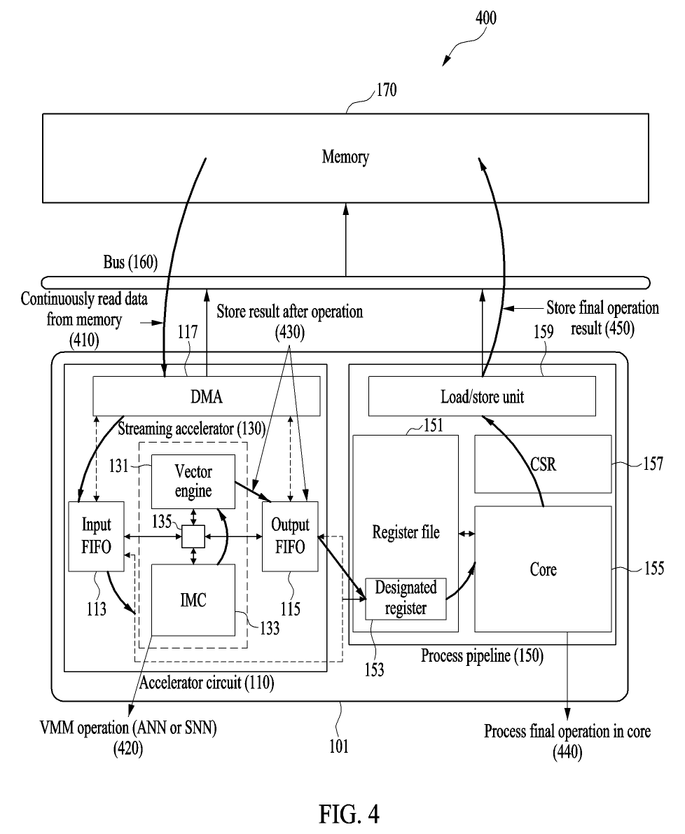

FIG. 4 illustrates an example of an operation between a processor and a memory, according to one or more embodiments. In FIG. 4, diagram 400 shows the operation of the core 155 communicating with the streaming accelerator 130 using a portion (e.g., the designated register 153) of a general-purpose register.

Through operations 410 to 450, the core 155 may start an operation and store the final operation processing result of the operation of the streaming accelerator 130 into the memory 170.

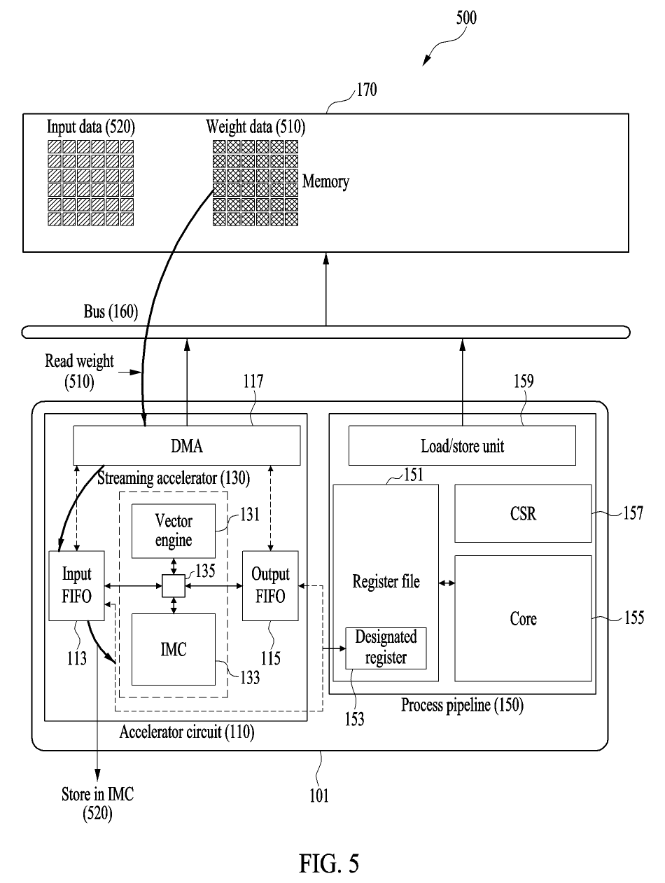

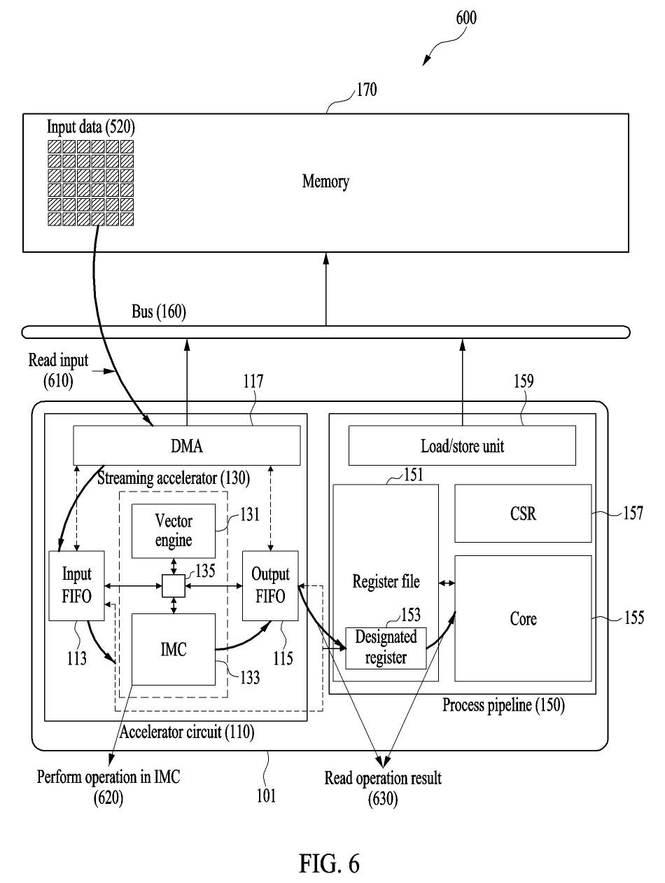

In operation 410, based on a setting of the CSR 157, the core 155 may enable the DMA device 117 to continuously read data (e.g., weight data 510 shown in FIG. 5 or input data 520 shown in FIG. 6) from the memory 170 and store the read data into the input FIFO 113 of the streaming accelerator 130. Then, the core 155 may continuously reset the DMA device 117 to read the data from the memory 170. The streaming accelerator 130 may be configured to receive the data from the input FIFO 113 and output an operation result corresponding to an operation between the data and whatever data is residing in the IMC device 133.

To that end, in operation 420, the IMC device 133 may receive the data stored in the input FIFO 113 and perform a VMM operation. In this case, the IMC device 133 may, for example, be configured as a 64x64 macro and include multiple macro instances rather than a single macro instance. The core 155 may select one of the multiple macro instances to use through the CSR 157. The IMC device 133 may transfer a VMM operation result to the vector engine 131 via the bridge device 135. The vector engine 131 may perform an operation (e.g., an SIMD-based operation) based on the VMM operation result. Some vector operations may be just on the VMM result (e.g., normalization), however, some vector operations may have two operands. If the VMM result is one of two operands of the vector engine, the other operand may be obtained as follows. The core 155 can preload the one of the operands (n elements) in the vector engine. An example of such a scenario is where the IMC computes VMM results, and those results go through the vector engine for bias-addition and multiplication. In this scenario, one set of operands may be fixed while the others are streaming in from IMC. Since the core 155 has a direct connection to the streaming computing units (IMC and vector engine), the core 155 should load one of the operands at this point. If both operands need to change, the core 155 can control the vector engine load and IMC streaming sequentially (over several cycles) as it directly controls them.

In operation 430, the vector engine 131 may store a result of the operation based on the VMM operation result into the register file 151. The core 155 may set the designated register 153, that is, a streaming pointer, as an address register of an Iw instruction and execute the lw instruction to read data (e.g., the operation result of the vector engine 131) from the output FIFO 115.

In this case, the core 155 may turn "on" the CSR 157 and use a default hardwired register as the streaming pointer. After the data read through the DMA device 117 is processed and/or operated by the IMC device 133 and/or the vector engine 131, the core 155 may record (store) the data residing the output FIFO 115 into the memory 170. The core 155 may read the data according to (based on) the streaming pointer.

A read instruction specifying the x0 register as a parameter may fetch an operation result of the streaming accelerator 130 from the output FIFO 115. For instructions other than reading/writing to the x0 register, the existing/default setting value/behavior (e.g., "0") of the x0 register may be utilized (i.e., the x0 register may function as per the RISC-V architecture/ISA). While fetching data using the streaming pointer, the core 155 may perform other operations defined by the ISA of the processor 101 by using the register designated as the streaming pointer with its default behavior of being a zero-register, such as the operation of "add x2, x2, x0".

When data is not yet ready in the output FIFO 115, the core 155 may be stalled and wait for data. Once the data is ready in the output FIFO 115, in operation 440, the core 155 may read the data from the output FIFO 115 and perform the final operation processing. When the core 155 reads the output FIFO 115 before the output FIFO 115 is ready due to the operation speed of the IMC device 133 and/or the vector engine 131, the core 155 may enter a stall state, pausing an operation until data is available in the output FIFO 115. This operation may be automatically managed in hardware by the score board 340 described above with reference to FIG. 3.

In operation 450, the core 155 may store the final operation processing result into the memory 170 through the LSU 159. The core 155 may store the final operation processing result in the memory 170 using ordinary memory read/memory write commands.

In sum, as described above, the core 155 may fetch the data from the memory 170, process the data through the streaming accelerator 130, and receive the computed result. The core 155 may perform post-processing on the operation result of the streaming accelerator 130 and store the post-processed result in the memory 170. This post-processing may include, for example, bias addition and normalization, but examples are not limited thereto.

By designating the hardwired x0 register as a streaming pointer, data overhead between the core 155 and the streaming accelerator 130 may be reduced, while also reducing overhead for synchronization during frequent data transfers and/or access to external data. Additionally, the core 155 may directly access the data in the memory 170 without using the system bus 160 (i.e., using DMA technology), thus achieving program efficiency such as code reduction and performance improvement.

FIG. 5 illustrates an example of an operation in which a processor reads weight data from a memory and stores the weight data in an accelerator circuit, according to one or more embodiments. In FIG. 5, diagram 500 shows the process in which the core 155 controls the DMA device 117 (through a setting of the CSR 157) to load weight data 510 into the IMC device 133.

The core 155 may cause data (e.g., the weight data 510) to be fetched directly from the memory 170 through operations 510 and 520 and store the fetched data in the IMC device 133.

In operation 510, the core 155 may read the data (e.g., the weight data 510) for the IMC device 133 from the memory 170. Specifically, the core 155 may control the DMA device 117 (through the setting of the CSR 157) to read the weight data 510 from the memory 170. The core 155 may cause the fetched data (e.g., the weight data 510) to be stored (written) into the input FIFO 113. In this case, the core 155 may access the CSR 157 using a dedicated instruction.

In operation 520, the IMC device 133 may receive the data (e.g., the weight data 510) from the input FIFO 113 and store the data in an internal memory of the IMC device 133. While the IMC device 133 is storing the weight data 510 into the internal memory, when another instruction related to the IMC device 133 is decoded and it is required to wait until the operation of the IMC device 133 is completed, the operation of the core 155 may be paused.

The core 155 may execute an operation command for the IMC device 133 and an operation command for the vector engine 131. Here, the "execution" of an operation command may be decoding and transferring a corresponding instruction to an independent instruction control device (e.g., a controller) of the IMC device 133 and the vector engine 131. Corresponding instructions may be repeatedly executed in a loop form multiple times by the loop control unit described above.

The core 155 may fetch data for the IMC device 133 directly from a memory via the DMA device 117 or access the data directly through a streaming pointer.

FIG. 6 illustrates an example of a process in which a processor reads input data from a memory and transfers, to a core, a result obtained by performing an operation on the input data in an accelerator circuit, according to one or more embodiments. In FIG. 6, diagram 600 shows a process in which the core 155 controls the DMA device 117 (through a setting of the CSR 157) to apply input data 520 to the IMC device 133.

The core 155 may, through operations 610 to 630, fetch data (e.g., the input data 520) from the memory 170 and read a result obtained by performing an operation on the data in the IMC device 133.

In operation 610, the core 155 may cause the data (e.g., the input data 520) required for an operation of the IMC device 133 to be read from the memory 170. The core 155 may control the DMA device 117 (through a setting of the CSR 157) to read the input data 520 from the memory 170. The core 155 may cause the read data (e.g., the input data 520) to be stored (written) into the input FIFO 113.

In operation 620, the IMC device 133 may perform an operation (e.g., a VMM operation) between the input data 520 read through the input FIFO 113 and the weight data 510 residing in the internal memory of the IMC device 133 (e.g., as per FIG. 5).

In operation 630, the core 155 may read the operation result of the IMC device 133 from the output FIFO 115 using the designated register 153 of the register file 151. In this case, the core 155 may access the data (e.g., the operation result of the IMC device 133) using the designated register 153 as an address of the lw instruction. When the operation of the IMC device 133 is not yet completed and the data is not yet stored in the output FIFO 115, the core 155 may pause for the operation and wait until the data is stored in the output FIFO 115.

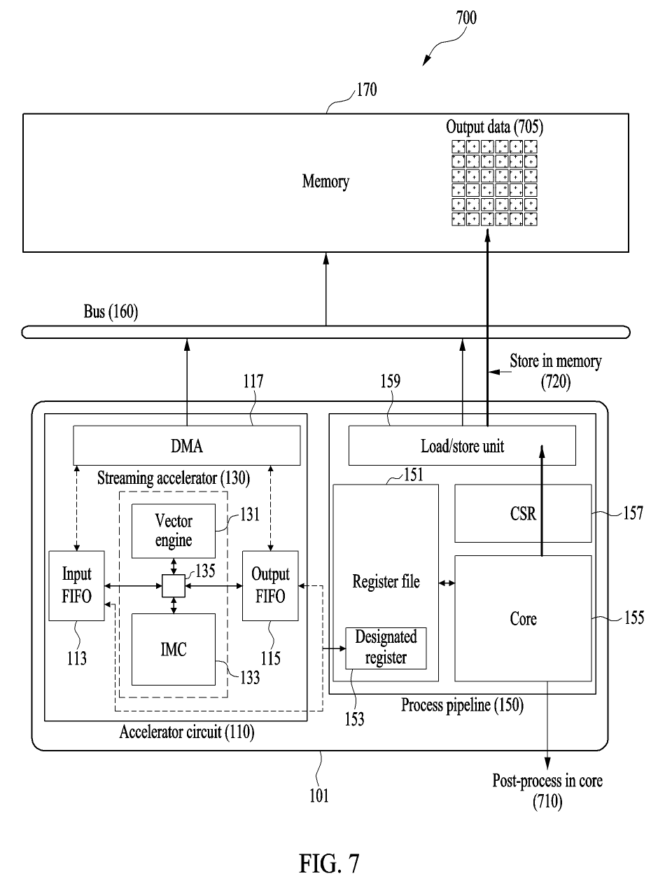

FIG. 7 illustrates an example of a process in which a processor stores a post-processing result of a core into a memory, according to one or more embodiments. In FIG. 7, diagram 700 shows a process in which the core 155 uses data read from the streaming accelerator 130 to store, into the memory 170, a result obtained by performing a post-processing operation.

The core 155 may store the post-processed data into the memory 170 through operations 710 and 720.

In operation 710, the core 155 may perform post-processing on the operation result of the IMC device 133 read from the output FIFO 115 via the designated register 153. The post-processing may include, for example, bias addition, normalization, batch normalization, and non-linear function operations, but examples are not limited thereto.

The core 155 may execute a read command using the x0 register as a source parameter/register of an instruction to read an operation result from another register (e.g., the output FIFO 115). The read command may be executed, for example, by an instruction such as "LD a1, 0(x0)". According to the read command, the core 155 may read a value of the output FIFO 115 and store the value in an a1 register. In this case, an offset added to a source register and/or a target register may be ignored. Additionally, the offset may be reinterpreted as the number of consecutive data items to be read. In this case, when the instruction "ld a1, 1(x0)" is executed, the core 155 may read the values of the output FIFO 115 and store the value in consecutive registers such as a1 and a2.

The core 155 may perform a post-processing operation on the data stored in the a1 register. The operation result read by the core 155 (according to the x0 register) may be an operation result of a matrix multiplication operation on input data. In this case, when the core 155 executes the instruction "add a1, a2, x0", a value of the x0 register may be recognized as "0" (e.g., functions as the zero-register).

For example, when the output FIFO 115 does not yet include the operation result of the IMC device 133, the pipeline of the core 155 may stall and wait until the data (e.g., the operation result of the IMC device 133) arrives in the output FIFO 115.

In operation 720, the core 155 may store the result of the post-processing performed in operation 710 into the memory 170 as output data 705.

The process described through FIGS. 4 to 7 is performed in a manner where the core 155 actively controls a program, aligning with the existing programming technique. Thus, even with the existing programming technique, the streaming accelerator 130, which includes the IMC device 133 and/or the vector engine 131, may be efficiently controlled/managed. The core 155 may not only perform a low-power AI operation through the IMC device 133 but also perform pre-processing and/or post-processing without having to first write the operation result of the IMC device 133 back to the memory 170.

The core 155 may access the input FIFO 113 and the output FIFO 115 of the IMC device 133 and/or the vector engine 131 through memory read/write operations that uses (e.g., specify) the designated register 153 and thus efficiently transmit and receive input and output data to and from the streaming accelerator 130. In this case, by utilizing a hardwired register (the designated register 153), it may be possible to avoid wasting a separate register for transmitting and receiving input and output data.

Additionally, the core 155 may perform operations in parallel across multiple sections using a loop command, providing a faster operation speed. The core 155 may ensure that the processes described above with reference to FIGS. 4 to 7 are performed in parallel in a pipelined manner.

A neuron model of an SNN may also be configured in a programmable form in the core 155 and the vector engine 131.

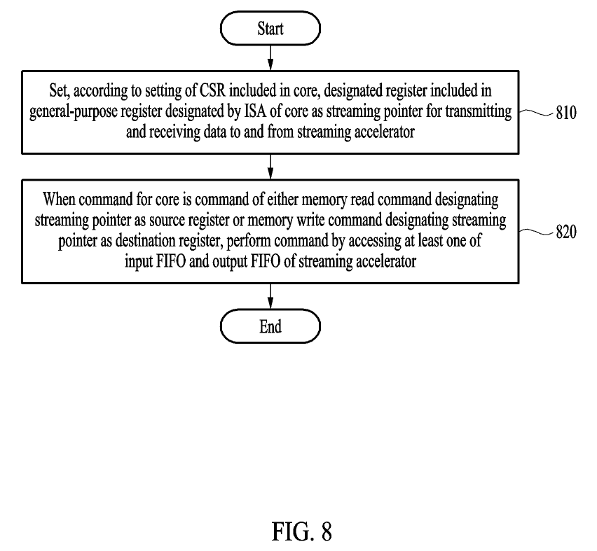

FIG. 8 illustrates an example of an operating method of a processor, according to one or more embodiments.

Referring to FIG. 8, the processor may perform a command through operations 810 and 820.

In operation 810, the processor may set, according to a setting of a CSR included in a core, a designated register (which may be included in a general-purpose register designated by an ISA of the core) to function as a streaming pointer for transmitting and receiving data to and from a streaming accelerator. In this case, the designated register may be used as a designated point for data access.

As noted, the processor may obtain the designated register of the general-purpose register to function as the streaming pointer, and the designated register may be hardwired according to the ISA of the core (e.g., may be zero-register). Additionally, the processor may set the designated register of the general-purpose register as the streaming pointer, the designated register being designated by the setting of the CSR.

The processor may set the CSR based on a command for the core. The CSR setting(s) may indicate, for example, a setting of whether the streaming pointer is being used, designation of the streaming pointer, and/or a control register for operating a DMA device.

According to settings of the CSR and an LSU, the processor may check whether the designated register is used as a source register or a destination register of a memory command, and based thereon, may map the streaming pointer to a write port of an input FIFO corresponding to a memory write command or to a read port of an output FIFO corresponding to a memory read command.

Additionally, the processor may fetch weight data or input data into an IMC device included in the streaming accelerator through the input FIFO by controlling the control register for operating the DMA device. The core may directly access the memory through the DMA device.

In operation 820, when a command for the core is a command of either (i) a memory read command designating the streaming pointer as a source register or (ii) a memory write command designating the streaming pointer as a destination register, the core may perform the command of either the memory read command or the memory write command by accessing the input FIFO or the output FIFO.

For example, when the command is a read command designating the streaming pointer as a read address, the processor may perform data reading from the output FIFO. The processor may perform data reading by reading an operation result of the streaming accelerator from the output FIFO using the streaming pointer. In this case, when the operation result of the

streaming accelerator is not residing in the output FIFO, the processor may wait for the result to be stored.

When the command is a write command designating the streaming pointer as a write address, the processor may perform data writing to the input FIFO. The processor may perform data writing by recording the data read from the memory into the input FIFO using the streaming pointer. In this case, when the data writing is impossible due to the input FIFO being full, the core may suspend the data writing by temporarily stalling a pipeline.

Alternatively, when the command is a command other than the memory read command and the memory write command, the processor may perform the command other than the memory read command and the memory write command using a value stored in the designated register as-is, based on an operation defined by the ISA (e.g., the designated register may function as the zero-register).

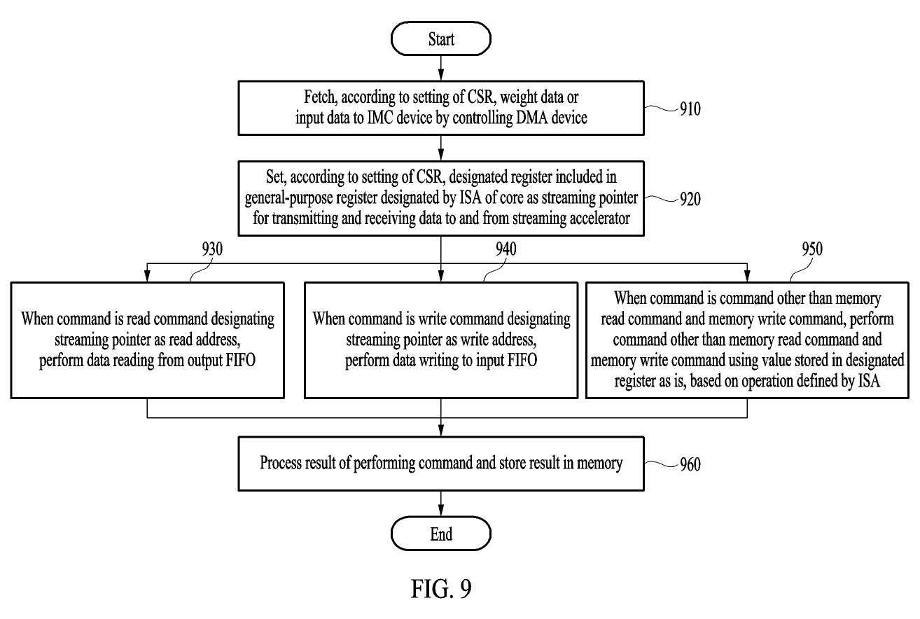

FIG. 9 illustrates an example of an operating method of a processor, according to one or more embodiments. Referring to FIG. 9, the processor may store a result of performing a command in a memory through operations 910 to 960.

In operation 910, the processor may fetch weight data or input data to an IMC device by controlling a DMA device according to a setting of a CSR included in a core.

In operation 920, the processor may set, according to the setting of the CSR, a designated register included in a general-purpose register connected to the core as a streaming pointer for transmitting and receiving data to and from a streaming accelerator.

In operation 930, when a command is a read command designating the streaming pointer as a read address, the processor may perform data reading from the output FIFO.

In operation 940, when the command is a write command designating the streaming pointer as a write address, the processor may perform data writing to the input FIFO.

In operation 950, when the command is a command other than the memory read command and the memory write command, the processor may perform the command other than the memory read command and the memory write command using a value stored in the designated register as is, based on an operation defined by the ISA.

In operation 960, the processor may process (e.g., post-process) the results of performing the commands in operation 930, operation 940, or operation 950 and store the

results in the memory. The processor may also store the results of performing the commands in operation 930, operation 940, or operation 950 directly in the memory without any processing.

The computing apparatuses, the electronic devices, the processors, the memories, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component

may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media.

Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An operating method of a processor, the operating method comprising:
setting, according to a setting of a control and status register (CSR) comprised in a core, a designated register as a streaming pointer for transmitting and receiving data to and from a streaming accelerator, wherein the designated register is comprised in a general-purpose register file according to an instruction set architecture (ISA) of the core; and
based on an instruction for the core either being a memory read instruction having the streaming pointer as a source register or being a memory write instruction having the streaming pointer as a destination register, performing either the memory read instruction or the memory write instruction by accessing an input first in first out (FIFO) buffer or an output FIFO buffer of the streaming accelerator.

2. The operating method of claim 1, wherein the designated register is a hardwired zero-register specified by the ISA of the core.

3. The operating method of claim 1, further comprising changing the setting of the CSR to cause the designated register to stop functioning as the streaming pointer.

4. The operating method of claim 1, wherein:
performing data reading from the output FIFO buffer based on the instruction being the read instruction having the streaming pointer as a read address; and
performing data writing to the input FIFO buffer based on the instruction being the write instruction having the streaming pointer as a write address.

5. The operating method of claim 4, wherein the performing of the data reading comprises reading an operation result of the streaming accelerator from the output FIFO buffer using the streaming pointer.

6. The operating method of claim 5, wherein the performing of the data reading further comprises waiting for the operation result to be stored in response to the operation result of the streaming accelerator not residing in the output FIFO buffer.

7. The operating method of claim 4, wherein the performing of the data writing comprises writing by recording data read from a memory into the input FIFO buffer using the streaming pointer.

8. The operating method of claim 7, wherein the performing of the data writing further comprises suspending the data writing by temporarily stalling a pipeline in response to the input FIFO buffer being full.

9. The operating method of claim 1, further comprising:
while the setting of the CSR remains set and designated register continues to function as the streaming pointer, performing a second instruction of the core which has the designated register as a parameter thereof by using the designated register as defined by the ISA.

10. The operating method of claim 1, further comprising:
setting the CSR based on a third instruction of the core,
wherein the CSR indicates either whether the streaming pointer is used, designation of the streaming pointer, or a control register for operating a direct memory access (DMA) device.

11. The operating method of claim 10, further comprising:
fetching, according to the setting of the CSR, weight data or input data to an in-memory computing (IMC) device comprised in the streaming accelerator through the input FIFO buffer by controlling the control register for operating the DMA device.

12. The operating method of claim 1, further comprising:
directly accessing, as instructed by the core, memory through a direct memory access (DMA) device.

13. A processor comprising:
an accelerator circuit comprising an input first in first out (FIFO) buffer, an output FIFO buffer, and a streaming accelerator configured to perform an operation on data received from the input FIFO buffer and to store a result of the operation into the output FIFO buffer; and
a core configured to perform an instruction by setting, according to a setting of a control and status register (CSR), a designated register as a streaming pointer for transmitting and receiving data to and from the streaming accelerator and accessing the input FIFO buffer or the output FIFO buffer of the accelerator circuit.

14. The processor of claim 13, wherein, based on the instruction either being a memory read instruction having the streaming pointer as a source register or being a memory write instruction having the streaming pointer as a destination register, the core is configured to perform the instruction by accessing the input FIFO buffer or the output FIFO buffer.

15. The processor of claim 13, wherein the designated register is a hardwired zero-buffer defined by the ISA.

16. The processor of claim 13, wherein the streaming accelerator comprises:
a vector engine, which is a single instruction multiple data (SIMD)-based operation device configured to operate a plurality of pieces of data simultaneously; and
an in-memory computing (IMC) device configured to perform a vector-by-matrix multiplication (VMM) operation on data stored into the IMC device from a memory.

17. The processor of claim 13, wherein the core is configured to, according to the setting of the CSR, map the streaming pointer to a write port of the input FIFO buffer or to a read port of the output FIFO by checking, in a load/store unit (LSU) or a decoder unit, whether the designated register is used as a source register or a destination register of the instruction.

18. The processor of claim 13, wherein the core is configured to:
in response to the instruction being a read instruction that includes the streaming pointer as a read address thereof, perform data reading by reading an operation result of the streaming accelerator from the output FIFO buffer; and
in response to the instruction being a write instruction that includes the streaming pointer as a write address thereof, perform data writing by recording data read from a memory into the input FIFO buffer.

19. The processor of claim 13, further comprising:
a direct memory access (DMA) device configured to read data from a memory and transmit the data to the input FIFO buffer and read data from the output FIFO buffer and transmit the data to the memory or to the input FIFO buffer.

20. A processor comprising:
an accelerator comprising an in-memory computing (IMC) device and/or a vector engine;
a core having a register file that includes a zero-register;
an input first in first out (FIFO) buffer and an output FIFO buffer providing communication into and out of the accelerator, respectively; and
the processor configured to:
turn a setting in a control and status register (CSR) of the core on and off,
based on the setting being on and based on a first instruction of the core having the zero-register as a parameter thereof, executing the first instruction by either writing data of the first instruction to the input FIFO buffer or reading data of the first instruction from the output FIFO buffer, and
based on the setting being off and based on a second instruction of the core having the zero-register as a parameter thereof, executing the second instruction by reading hardwired zeros from the zero-buffer.
